(19) United States
(12) Patent Application Publication
(10) Pub. No.: US 2009/0089653 A1
(43) Pub. Date: Apr. 2, 2009

(54) AUTO-GENERATION AND SYNDICATION OF TABLES AS FORMS

(75) Inventors: John Campbell, Renton, WA (US); Clinton Dee Covington, Kirkland, WA (US); Daniel Parish, Kirkland, WA (US); Eran Megiddo, Bellevue, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/863,459

(22) Filed: Sep. 28, 2007

(51) Int. Cl. G06F 3/14

(52) U.S. Cl. 715/209; 715/212; 715/222

(57) ABSTRACT

Techniques for automatically generating a form associated with a spreadsheet table are disclosed herein. Such a form may have data entry fields that correspond to data attributes listed on the spreadsheet table. The form may be associated with the spreadsheet table by means of a user interface, such as an icon or other object oriented user interface. In this way, a command to display the form may be provided with one click of a pointing device. The form may be generally associated with each entry in the spreadsheet table so that the data from a selected entry is displayed. Besides entering new data or revising existing data, browsing of existing data in the spreadsheet table may also be performed through navigation mechanisms contained on the form. Techniques for syndicating a form associated with a spreadsheet table or workbook into a web page are also disclosed herein.

### BACKGROUND

Spreadsheet applications are commonly used programs that provide a convenient, simple and intuitive way to enter, organize, manage, view, store, and search for data. Spreadsheet applications typically organize data into tables with rows and columns. Each column typically represents a particular data attribute. For example, a “Donations” table including data corresponding to charitable donations may have columns such as name (e.g., donator name), address, city, state, zip code, email, and pledge amount. One of the columns may be a key column that is used to order the rows of the table. For example, the key column of the Donations table may be the name column. Each row of the table typically includes data corresponding to a particular key column entry. For example, if a first entry in the name column of the Donations table is “John Doe,” then the first row of the Donations table may include an address, city, state, zip code, email, and pledge amount for John Doe.

One drawback of conventional spreadsheets is that tables are not always the most convenient structure with which to enter or view data. For example, when a user is entering or viewing data for a particular data table row, the user may wish to view only the data for that row. But a table format typically forces the user to view multiple rows of the table rather than displaying only a single row at a time. It is often difficult and confusing for users to concentrate and focus on a single row when multiple other rows are also being displayed. Additionally, because cells of the table are not always immediately adjacent to a corresponding column header or key column entry, it is often difficult for users to determine a particular column header or key column entry to which a particular cell corresponds, which may cause data to be inputted to the wrong column.

A form is an alternative structure for entering and viewing data. Forms may include a number of data entry fields each corresponding to a particular data attribute. For example, a “Donations” form including data corresponding to charitable donations may have data entry fields such as name (e.g., donator name), address, city, state, zip code, email, and pledge amount. Each “entry” of a form typically includes a corresponding data value for each of the data entry fields included in the form. Unlike tables that display multiple rows, forms typically display only a single form entry (also referred to as a record) at a time. Additionally, unlike in tables, each data entry field in a form is typically displayed adjacent to a label that names or identifies the corresponding data entry field. Another advantage of a form (specifically a syndicated form where users don't have to actually open a spreadsheet table to add or edit data in the spreadsheet table) is that it provides a mechanism for individual users to enter data into the spreadsheet table without necessarily allowing the individual users to view the entire set of data in the spreadsheet table. This “private” data entry may be particularly advantageous when the data being entered is personal or private in nature such as, for example, when collecting people's reviews and/or opinions about a certain topic. Thus, while tables provide several advantages, there are some scenarios in which it may be advantageous to use a form in combination with a table.

### SUMMARY

Techniques for automatically generating a form associated with a spreadsheet table are disclosed herein. One exemplary technique includes generating a form representative of the spreadsheet table, where the form generated has data entry fields that correspond to data attributes listed on the spreadsheet table. The form may be associated with the spreadsheet table by means of a user interface, such as an icon or other object oriented user interface. In this way, a command to display the form may be provided with one click of a pointing device. The form may be generally associated with each entry in the spreadsheet table so that the data from a selected entry is displayed. If the entry selected does not contain any data, then the form will may be blank so that new data may be entered into the spreadsheet table via the form. Besides entering new data or revising existing data, browsing of existing data in the spreadsheet table may also be performed through navigation mechanisms contained on the form.

Techniques for syndicating a form associated with a spreadsheet table or workbook into a web page are also disclosed herein. By embedding code for the form into a web page, spreadsheet services connected thereto may be utilized to update the information in the spreadsheet table.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The illustrative embodiments will be better understood after reading the following detailed description with reference to the appended drawings, in which:

FIG. 1 is a block diagram an exemplary computing device;

FIG. 2 is a representation of a screen display depicting an exemplary spreadsheet table, where a form associated with each entry in the spreadsheet table is shown in a separate window overlaying the spreadsheet table;

FIG. 3 is a flow chart depicting the steps of a method for entering data into a spreadsheet table via a form associated with each entry thereof;

FIG. 4 is a block diagram depicting a system for syndicating a form in a web page so that data entered into the form is automatically provided to a spreadsheet table associated therewith; and,

FIG. 5 is a flow chart depicting the steps of a method for automatically entering and updating data into a spreadsheet table via a form syndicated in a web page.

### DETAILED DESCRIPTION

The inventive subject matter is described with specificity to meet statutory requirements. However, the description itself is not intended to limit the scope of this patent. Rather, it is contemplated that the claimed subject matter might also be embodied in other ways, to include different steps or combinations of steps similar to the ones described in this document, in conjunction with other present or future technologies

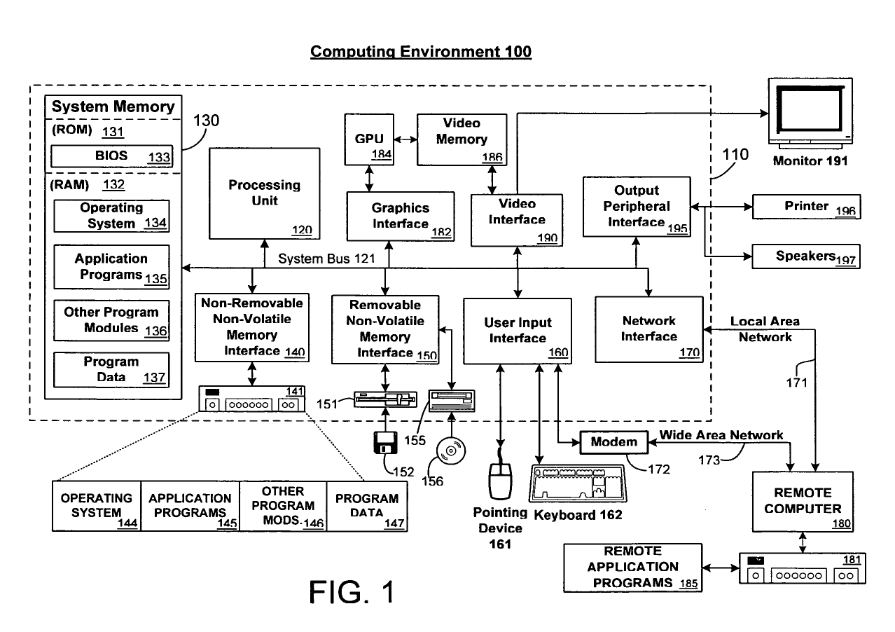

FIG. 1 illustrates an example of a suitable computing system environment 100 in which the subject matter described above may be implemented. The computing system environment 100 is only one example of a suitable computing environment and is not intended to suggest any limitation as to the scope of use or functionality of the subject matter described above. Neither should the computing environment 100 be interpreted as having any dependency or requirement relating to any one or combination of components illustrated in the exemplary operating environment 100.

With reference to FIG. 1, computing system environment 100 includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embody computer readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-RW, DVD-RW or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136 and program data 137. Operating system 144, application programs 145, other program modules 146 and program data 147 are given different numbers here to illustrate that, at a minimum, they are different copies. A user may enter commands and information into the computer 110 through input devices such as a keyboard 162 and pointing device 161, such as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182 may also be connected to the system bus 121. One or more graphics processing units (GPUs) 184 may communicate with graphics interface 182. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

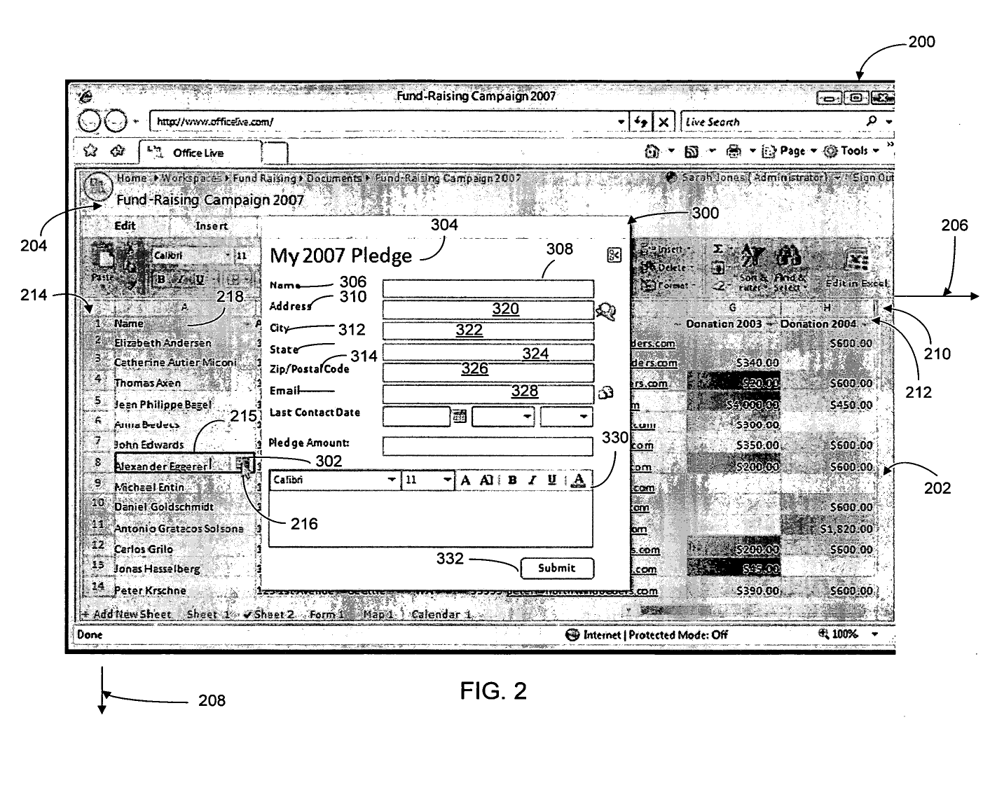

FIG. 2 depicts an exemplary display 200 including a spreadsheet table 202 that may be presented by monitor 191. An area 204 is generally provided so that a title or other identifier can be included for spreadsheet table 202. It will further be seen that spreadsheet table 202 preferably includes a first axis 206 extending horizontally and a second axis 208 extending vertically. A plurality of columns 210 are preferably provided across first axis 206, where a heading 212 is typically provided for each column designating a particular data attribute to be listed thereunder. A plurality of rows 214 are preferably provided along second axis 208, where data is able to be input within a cell that is aligned with each column for a particular entry. It will be noted that various other items are generally included on display 200, such as tool bars and other functional icons, which assist in the constructing and formatting of spreadsheet table 202.

As seen in FIG. 2, for example, spreadsheet table 202 is entitled “Fund-Raising Campaign 2007” in area 204 of display 200. The various entries are provided in each numbered row, where each entry is a person and certain data is provided within each designated column 210. While not completely visible, it will be understood that headings 212 for columns 210 in spreadsheet table 202 include Name, Address, City, State, Zip/Postal Code, Email, Donation 2003, and Donation 2004.

In order to provide an alternative to entering/revising or reviewing data directly into or from spreadsheet table 202, a form 300 is preferably associated with spreadsheet table 202 and automatically generated upon command. While access to form 300 may be accomplished in a number of ways, it is seen from FIG. 2 that a form icon 302 is preferably provided within a cell 215 for a particular entry in spreadsheet table 202 upon selection. It will be understood that an entry is selected, for example, when a pointer 216 from pointing device 161 is positioned over the cell of a particular entry. In the exemplary display, it will be seen that pointer 216 is positioned over cell 215 aligned with a first column 218 of an entry 220 in spreadsheet table 202, but pointer 216 may be positioned over any cell (aligned with any column) for such entry to obtain form icon 302. Form icon 302 is typically known as an object oriented user interface, as clicking upon it with pointing device 161 provides access to form 300. Thus, access to form 300 from spreadsheet table 202 is easily available. As should be appreciated, other techniques such as keyboard commands and voice commands may also be employed to select an entry from spreadsheet table 202 and gain access to form 300.

More specifically, form 300 is loaded to display information from either the selected entry or with blanks if it is a new entry. It will be understood that the default mode for form 300 is as a “new entry” if no entries exist in spreadsheet table 202. Otherwise, it is preferred that the data from spreadsheet table 202 for a selected entry will automatically fill a text box corresponding to column headings 212. A title 304 is preferably provided for form 300, where such title will typically be the same as that for spreadsheet table 202 unless modified. Since form 300 is preferably laid out vertically, it further includes a plurality of fields representing column headings 212 along with a corresponding text box for each adjacent thereto. Accordingly, exemplary form 300 includes a first field 306 representative of the first or left column in spreadsheet table 202 (i.e., “Name”) and a text box 308 corresponding thereto. Similarly, a second field 310, a third field 312, a fourth field 314, a fifth field 316 and a sixth field 318 are provided in form 300, along with text boxes 320, 322, 324, 326 and 328 adjacent thereto (i.e., “Address,” “City,” “State,” “Zip/Postal Code,” and “Email”). Additional fields and corresponding text boxes may be included in form 300 beyond the data entered into spreadsheet table 202 if desired, as seen in FIG. 2. One such addition to form 300 preferably includes a rich text edit box 330 (along with formatting controls) so that notes, comments and other pertinent information for an entry may be recorded for future reference.

It will be understood that the text boxes in form 300 will preferably be formatted for the type of data entered or displayed therein. As such, certain text boxes will be left justified (e.g., general, text, or other) or right justified (e.g., number, time, fraction, or scientific). Text boxes may also be formatted to include a symbol therewith (e.g., a currency symbol displayed to the left thereof when the data involves currency/accounting and a percent symbol displayed to the right thereof when a percentage is entered). In order to assist with the entry of certain data types, an icon representative of a control may also be located adjacent a text box (e.g., a date picker control for the entry of a date). Special treatment for some data types is provided, such as when the application program understands such type implicitly. For example, the text box for a web address may be left justified and include a control adjacent thereto that when clicked opens a new web browser window and navigates the user to the specified web address. Similarly, the text box for an email address may also be left justified and include a control adjacent thereto that when clicked will open the user's default email program and open a new message to the specified recipient. Finally, certain data types may automatically be detected based on the heading of the column. The text box for a street address, for example, may be left justified and include a control that when clicked displays a map of the specified location with a link that allows the user to open the map in a new web browser window.

Once data has been entered into form 300, it is then transferred to spreadsheet table 202 by means of an appropriate button therein. If form 300 is used to add an entry, a “Submit” button 332 is provided so that when clicked, a new row is added to spreadsheet table 202 containing the entered data. If form 300 is used to edit an entry, an “Update” button (not shown) is preferably provided so that when clicked, the row in spreadsheet table 202 is modified to contain the modified data therein. A separate “Close” button (not shown) may be included in form 300 so that the separate window is closed and the user is returned to spreadsheet table 202 without any changes made thereto.

In order to better navigate between the various entries (or rows) within spreadsheet table 202 while form 300 is displayed, additional buttons may also be included therewith. Examples of such buttons include: a “Next entry” button which moves to the next entry in spreadsheet table 202; a “Previous entry” button which moves to the previous entry in spreadsheet table 202; a “First entry” button which moves to the first entry in spreadsheet table 202; and, a “Last entry” button which moves to the last entry in spreadsheet table 202. It will be understood that the “Next entry” button would be disabled if the user has reached the last entry of spreadsheet table 202 and the “Previous entry” button would be disabled if the user has reached the first entry of spreadsheet table 202. In this way, the data or information for each entry in spreadsheet table 202 may be reviewed within the form window.

Another item that may be provided within form 300 is a “New entry” button (not shown), where the information/data on form 300 from an existing entry is erased so that a new entry for spreadsheet table 202 may be added. This allows form 300 to be set up directly from a prior entry form instead of having to access it from spreadsheet table 202.

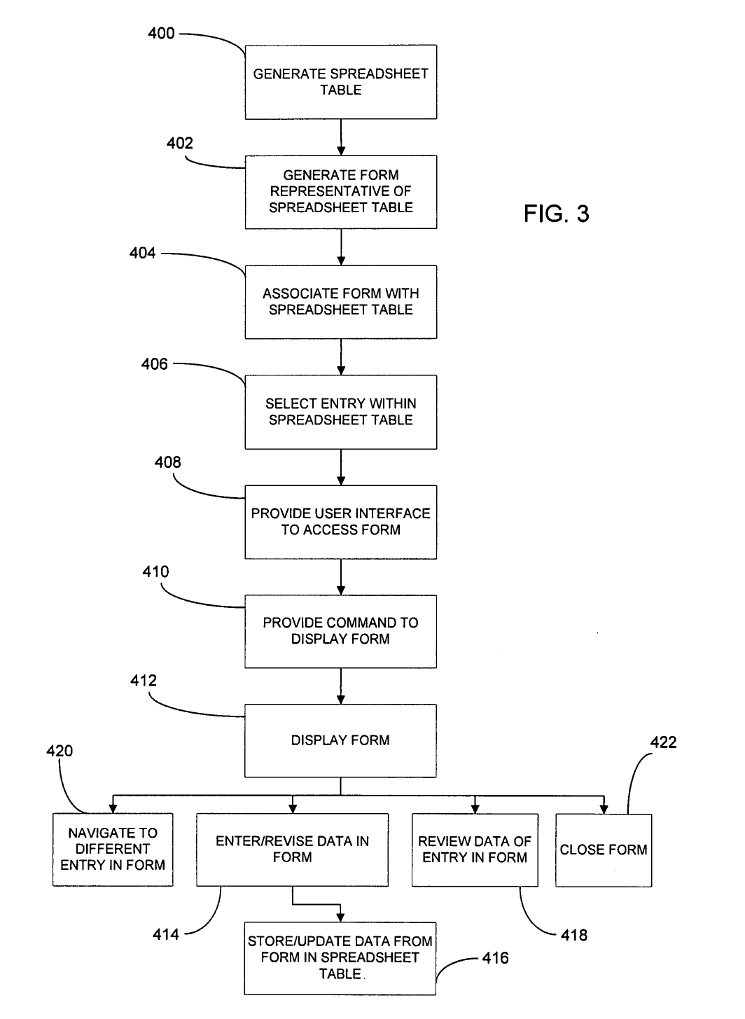

In accordance with the present invention, a method or process of responsively generating a form associated with a spreadsheet table is disclosed in FIG. 3. Initially, a spreadsheet table 202 is generated which includes first and second axes 206 and 208 (box 400). It will be understood that data attributes will preferably be listed with one of these axes, such as headings 212 for columns 210. Next, a form 300 is generated which is preferably representative of spreadsheet table 202 (box 402). As such, form 300 preferably includes fields and text boxes which correspond to at least some of the data attributes on spreadsheet table 202. Form 300 is then associated with spreadsheet table 202 (404). This may be accomplished through some type of user interface, such as form icon 302 described above. Thereafter, when a cell 215 within spreadsheet 202 is selected (box 406), the user interface (i.e., form icon 302) is preferably provided therein (box 408). By clicking on the user interface, a command is provided (box 410) which causes form 300 to be displayed (412) in response thereto.

Depending upon the cell selected (i.e., whether the entry is blank or contains data), information within spreadsheet table 202 may be entered or revised (box 414). Accordingly, such data in the form is then able to be stored or updated in spreadsheet table 202 (416). Of course, it is possible that data within an entry of spreadsheet table is merely reviewed (box 418), whereupon a user may navigate to a different entry in spreadsheet table 202 (box 420) or return to spreadsheet table 202 by closing form 300 (box 422).

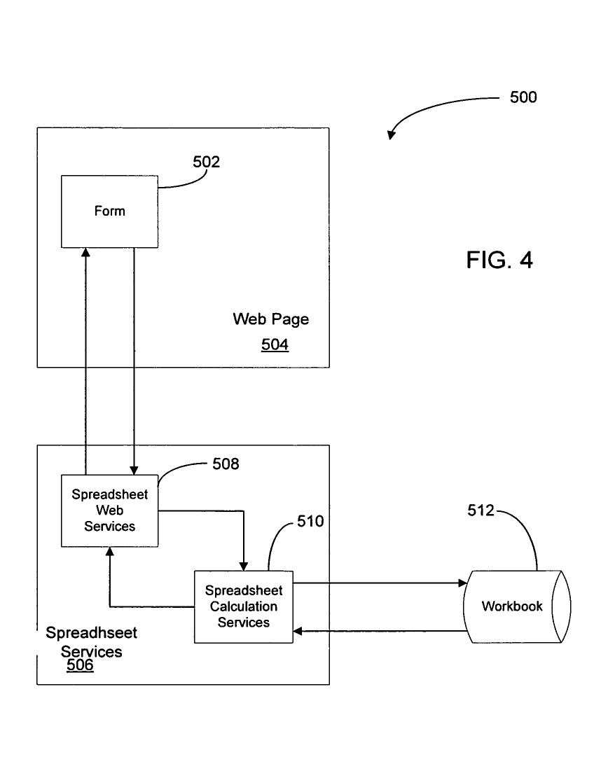

In order to further leverage the use of a form representative of and associated with a spreadsheet table, it is contemplated that such form may be utilized in conjunction with a web page. As seen in FIG. 4, an exemplary system 500 is depicted where a form 502 associated with a spreadsheet table has been syndicated into a web page 504. System 500 further includes spreadsheet services 506 connected to web page 504 which provides spreadsheet web services 508 and spreadsheet calculation services 510. Spreadsheet web services 508 may be utilized to assist in embedding form 502 in web page 504 and receiving information or data entered into form 502. When data from form 502 is submitted, a request is sent to spreadsheet services 506 so that a workbook 512 may be updated. Of course, some manipulation or calculation of the data received from form 502 may be desired by calculation services 510.

Form 502 may be embedded into web page 504 by, for example, using a clipboard tool or directly embedding the corresponding form code. To embed a form into a web site using a clipboard tool, a user may, for example, click a clipboard tool icon on the form, select which form view is desired, and then paste it into a clipboard tool enabled web page. It will be understood that this process involves the necessary code for the selected form to be automatically placed on the clipboard tool so that the code may then be automatically pasted into the web site. To embed a form using the code approach, a user may, for example, utilize a syndication user interface that permits the user to choose a spreadsheet table with which to syndicate a form and select the desired form view. A code snippet may then be presented which can be embedded into the web page.

It will further be appreciated that the view of form 502 may take one of a number of views. In one such view, form 502 will only allow the entry of new items. Therefore, none of the browsing features which permit navigation to other entries, as indicated hereinabove, will be displayed. This may allow “private” data entry by allowing individual user to enter data into a spreadsheet table without seeing the complete set of data entered into the spreadsheet table. Alternatively, form 502 may allow users only to browse current entries in the spreadsheet table associated with form 502. The controls associated with the entry of data for new items will not be displayed in such view. Of course, the Close button described herein will not be shown in either view since form 502 is embedded in web page 504.

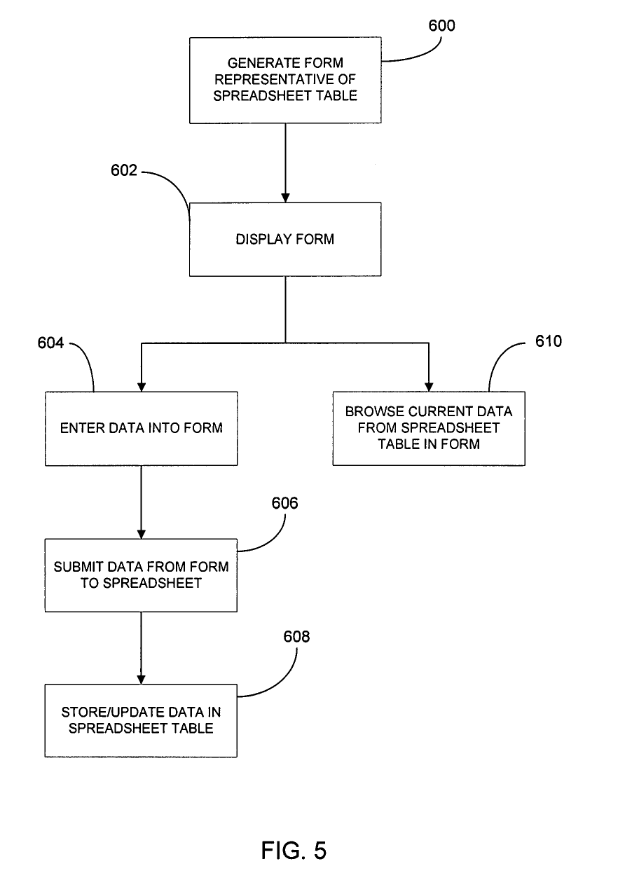

While use of a form in a web page has been described, where such form is associated with a spreadsheet table or workbook, it will be understood that a method or process for storing or updating data in a workbook is disclosed. It will be seen in box 600 of FIG. 5 that a form 502 is first generated which is representative of a spreadsheet table. The form may is then displayed (box 602). The form 502 may, for example, be displayed on a web page 504. If the form is displayed on a web page 504, code for the form 502 may be embedded into web page 504 (box 602). As described herein, such code may be embedded directly or by means of a clipboard tool. After form 502 is displayed, data may then be entered into form 502 (box 604) and then submitted to the spreadsheet (box 606). In this way, the data from form 502 is stored/updated in the spreadsheet table or workbook (608). Of course, when the view of form 502 is for browsing only, current items or entries in the spreadsheet table are displayed (box 610).

Although the subject matter has been described in language specific to the structural features and/or methodological acts, it is to be understood that the subject matter defined in the appended claims is not necessarily limited to the specific features or acts described above. Rather, the specific features or acts described above are disclosed as example forms of implementing the claims.

What is claimed:

1. A computer-readable medium having stored thereon computer-executable instructions for performing a process comprising:
generating a spreadsheet table;
generating a form representative of the spreadsheet table;
associating the form with the spreadsheet table;
receiving a command to display the form associated with the spreadsheet table; and, responsively displaying the form associated with the spreadsheet table.

2. The computer-readable medium of claim 1, wherein the process further comprises storing new data in the spreadsheet table entered into the form.

3. The computer-readable medium of claim 1, wherein the process further comprises providing a user interface on the spreadsheet table to access the form for a specified entry of the spreadsheet table.

4. The computer-readable medium of claim 1, wherein the process further comprises formatting the form so as to include data entry fields corresponding to data attributes of the spreadsheet table.

5. The computer-readable medium of claim 4, wherein the process further comprises displaying existing data in the data entry fields corresponding to data attributes of the spreadsheet table for a specified entry of the spreadsheet table.

6. The computer-readable medium of claim 4, wherein the process further comprises receiving revised data in the data entry fields corresponding to data attributes of the spreadsheet table for a specified entry of the spreadsheet table.

7. The computer-readable medium of claim 4, wherein the process further comprises receiving new data in the data entry fields corresponding to data attributes of the spreadsheet table for a specified entry of the spreadsheet table.

8. The computer-readable medium of claim 1, wherein the process further comprises providing a mechanism in the form for navigating to different entries in the spreadsheet table.

9. The computer-readable medium of claim 1, wherein displaying the form associated with the spreadsheet table comprises displaying a new item view that allows entry of new items in the spreadsheet table.

10. The computer-readable medium of claim 1, wherein displaying the form associated with the spreadsheet table comprises displaying a browse view that allows browsing of current items in the spreadsheet table.

11. The computer-readable medium of claim 10, wherein displaying the browse view comprises displaying navigation controls for navigating from one entry to another.

12. The computer-readable medium of clam 1, wherein the process further comprises embedding the form in a web page.

13. The computer-readable medium of clam 12, wherein the form is embedded in the web page using a clipboard tool.

14. The computer-readable medium of clam 12, wherein the form is embedded in the web page by directly embedding code corresponding to the form into the web page.

15. A computer-readable medium having stored thereon computer-executable instructions for performing a process comprising:
generating a form associated with a spreadsheet table, the form comprising data entry fields corresponding to data attributes of the spreadsheet table;
receiving a submitted form entry comprising a data value for each of the data entry fields;
entering each data value from the form entry into a corresponding a cell of the spreadsheet table in accordance with the data attributes of the spreadsheet table; and,
storing the spreadsheet table including the entered data values.

16. The computer-readable medium of clam 15, wherein the process further comprises embedding the form in a web page.

17. The computer-readable medium of clam 16, wherein the form is embedded in the web page using a clipboard tool.

18. The computer-readable medium of clam 16, wherein the form is embedded in the web page by directly embedding code corresponding to the form into the web page.

19. The computer-readable medium of claim 15, wherein generating the form comprises displaying a new item view that allows entry of new items in the spreadsheet table.

20. A method for generating a form associated with a spreadsheet table comprising:
generating the spreadsheet table;
generating the form representative of the spreadsheet table;
associating the form with the spreadsheet table;
receiving a command to display the form associated with the spreadsheet table; and,
responsively displaying the form associated with the spreadsheet table.
